(19) United States
(12) Patent Application Publication
(10) Pub. No.: US 2014/0208220 A1
(43) Pub. Date: Jul. 24, 2014

(54) System and Method for Contextual and Collaborative Knowledge Generation and Management Through an Integrated Online-Offline Workspace

(71) Applicant: Aditya Watal, Allahbad (IN)

(72) Inventor: Aditya Watal, Allahbad (IN)

(21) Appl. No.: 14/128,601

(22) PCT Filed: Mar. 1, 2012
(86) PCT No.: PCT/IN2012/000144

§ 371 Date: Mar. 21, 2014

(30) Foreign Application Priority Data
Mar. 1, 2012 (IN) 1771/DEL/20122

(51) Int. Cl. H04L 29/08; G06F 3/0482; G06F 3/0481

(52) U.S. Cl. CPC H04L 67/10; G06F 3/04817; G06F 3/0482
USPC 715/738

(57) ABSTRACT

The present invention discloses a computer-implemented online-offline workspace and method for creating, developing, storing, and managing digital content within a contextual and shared knowledge network. The invention includes a central service facility that provides an online platform for the users to work in a context-based and shared knowledge environment through a user interface on a wide range of user access devices. The online platform is embedded with a plurality of applications to allow the user to capture, create, develop, store, process, share, distribute, retrieve, reuse, and manage digital contents containing any one or a combination of the following: text, graphics, audio, video, whole or portions of web-pages and web-links. The invention further includes an end-user facility providing an offline platform that gets synchronized with the online platform upon detection of a secured communication network.

### BACKGROUND

The invention relates generally to creation and management of digital content through an integrated online-offline workspace, and in particular to a system comprising of a seamlessly integrated online and offline platforms, characterized by a context based collaborative environment and a service framework, for creating, developing, processing, distributing, and managing digital content.

The advent of computer and Internet has revolutionized the way people work and access information for various purposes. For example, a user can send near instant messages to someone across the globe on a click. Additionally, web browsers allow the user to look for desired information through trillions of web pages. While such ease of access to information and computing provide many advantages to a person or an entity, the current platforms and/or service frameworks limits the utilization of true potential of computer and Internet. For example, multiple documents and files pertaining to a single project may be created, accessed, developed, and uploaded from multiple locations by one or more users. This is because multiple users work from multiple computing devices available at multiple locations—a personal desktop computer at home, a work terminal at office, a desktop computer at library or other public places, a personal laptop or hand held computing device, or an official laptop or hand held computing device. Additionally, many users work in teams such that the same document or file may be accessed from and worked on at different computers in the same or different locations and at same or different time. As a consequence, users constantly have to physically transport files, saved website links, and other digital content between their multiple workstations. This results in multiple documents containing similar information and/or multiple versions of the same documents floating around at various locations or in various folders at the same locations. It is therefore difficult to filter and organize all the information related to same project in an efficient and convenient manner, particularly where multiple users in different locations are contributing to the project and developing the files and documents collaboratively. For example, it is not only difficult to ensure that all copies of the documents are updated to the latest version but it is also difficult to locate these documents, files and information when needed.

Some of the platforms and/or service frameworks that have come up recently allow the users to store, manage, view, or share their data from any location through an online platform. However, such online platforms are limited in their scope as they require the user access device to be on an active high-speed communication network. In order to work in an offline mode, the digital content must be manually downloaded by the user on his access device. Only after downloading the digital content locally on his access device, can the user edit it in an offline mode. Further, to have the flexibility to access this edited digital content from any other device, the user needs to manually upload the latest version of the digital content on the online platform. Moreover, the user needs to repeat this entire process each time any change needs to be made to the document. Such platforms therefore fail to provide for an integrated online and offline mode to enable the user to access and work on data with or without an active communication network. Additionally, existing platforms fail to provide for efficient handling of multiple documents containing similar information and/or multiple versions of the same documents that are accessed, compiled, and stored by one or more users.

It is therefore desirable to provide an integrated online-offline workspace and a corresponding service framework for improved, efficient and convenient digital content creation, manipulation, storage, management, and distribution in a context-based collaborative environment.

### BRIEF DESCRIPTION

Briefly in accordance with one aspect of the present invention, an integrated online-offline workspace and a corresponding service framework is provided for improved and efficient digital content creation, manipulation, storage, management, and dissemination in a context-based collaborative environment. The integrated online-offline workspace and the corresponding service framework enable a user or an enterprise to improve productivity and collaboration and to enhance knowledge generation and management.

In accordance with another aspect of the present invention, a computer-implemented system is provided for contextual and collaborative knowledge generation, management, and dissemination. The system includes multiple user devices in communication with a plurality of application servers that are in further communication with one or more data servers. The system facilitates an integrated online-offline workspace and a corresponding service framework designed to offer a context-based and collaborative workspace to the users through a variety of applications. The integrated online-offline workspace can be accessed by the user through a web browser, a web browser toolbar, and/or a device application from a host of devices such as a desktop computer, a laptop computer, a personal digital assistant (PDA), a smart phone, a mobile device, and so forth. The integrated online-offline workspace includes a plurality of embedded applications that help the user to create, manage, and share digital contents in a context based collaborative environment. The online workspace and the offline workspace are integrated through mutual communication with each other such that any addition, removal, or modification of any data item in any one of these workspaces accordingly adds, removes or modifies the corresponding data item on the other workspace upon establishment of a secured communication network on the user access device.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE ACCOMPANYING DRAWINGS

These and other features, aspects, and advantages of the present invention will become better understood when the following detailed description is read with reference to the accompanying drawings in which like characters and/or numerals represent like parts throughout the drawings, wherein:

FIG. 1 illustrates a representative networked computing system in accordance with aspects of the present invention.

FIG. 2 is a schematic block diagram of the present system in accordance with aspects of the invention.

FIG. 3 is a block diagram representing online and offline access modes for the online and offline platforms respectively in accordance with aspects of the present invention.

FIG. 4 is a flow diagram illustrating a user interface for viewing and managing digital contents in accordance with an aspect of the present invention.

FIG. 5 is a flow diagram illustrating the architecture of the service framework in accordance with aspects of the present invention.

FIGS. 6-15 are screen diagrams illustrating various aspects of the user interface in accordance with aspects of the present invention.

FIG. 16 is a snapshot illustrating a user interface for viewing and managing digital contents in an offline mode in accordance with an aspect of the present invention.

### DETAILED DESCRIPTION

The present invention is generally directed to an integrated online-offline workspace for contextual and collaborative knowledge generation and management. Such techniques may be useful for a variety of users, such as an individual, a team, an institutional, an enterprise, and so forth. Though the present discussion provides examples generally in context of an individual and/or a team, one of ordinary skill in the art will readily comprehend that the application of discussed features and tools in larger contexts, such as for an institution or an enterprise, is well within the scope of the present invention.

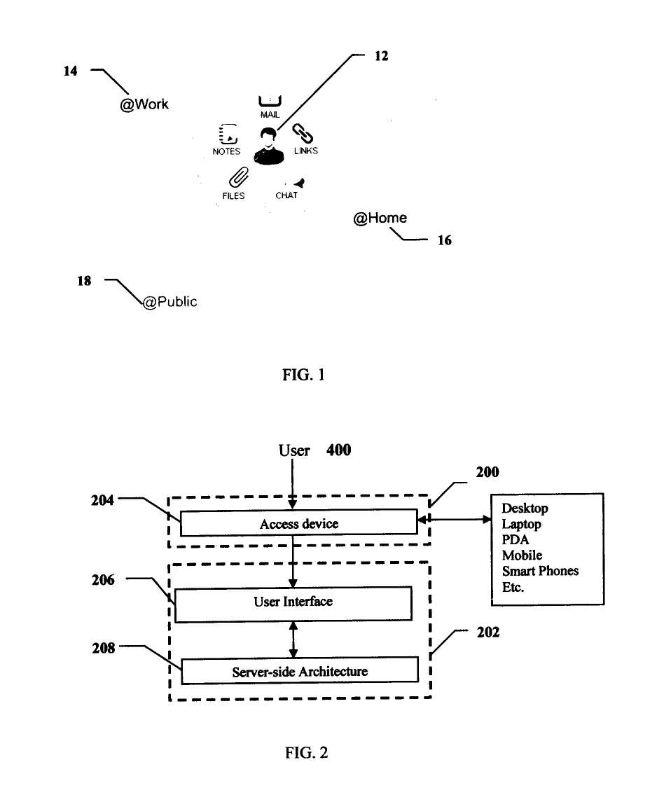

Referring now to FIG. 1, an exemplary networked computing system is illustrated in accordance with one aspect of the present technique. A user 12, in his individual capacity or as a part of the business, is almost always working on one or more projects at any given time frame. While working on any of these multiple projects, the user employs different computing and online tools like searching, bookmarking, documents and file sharing, chat, emails, blogs, storing, and so forth. For example, in the illustrated embodiment, the user 12 interacts with Internet to perform various tasks at different locations such as at work 14, at home 16, and at public places 18. The various tasks may include, but are not limited to, sending and receiving mails with friends, family, colleagues; creating and editing notes and other file (e.g., word, power point, excel, images, audio, and so forth) for self or for some collaborative project via sharing; chatting with friends or team members; browsing and saving the link for self and or for some collaborative project with friends, family, or other members of the team via sharing; and so forth. It should be noted that the sharing of the notes, files or link may be accomplished through email, chat, and/or other file sharing program.

All of these computing and/or online tools, applications, and services provide different methods and mediums of finding, creating, organizing, storing, and sharing the information. For example, a bookmarking application may allow a user to create, organize, and share the bookmarks. Similarly, a document/file sharing application may allow a user to create, organize and share documents. Further, if for any reason, the user employs two or more document sharing tools then the information is stored and managed in two different ways at two different places, often in addition local storage of this information on local mass storage device. It is desirable to tie all this information together across all these applications, tools, and storage services at one single place and preferable to access and view all these information in one single view in a relevant project context. The embodiments of the present invention enable a user to achieve above goal through an integrated, context-aware platform and/or browser based service framework over a trusted network communication.

Turning now to FIG. 2, three different levels of an embodiment of the present system are illustrated, namely, access level 200, interface level 206, and architecture level 208. Box 202 represents the integrated online/offline workspace and the corresponding service framework provided by the present system. A user 400 can access the integrated online/offline workspace and the corresponding services of the present system on multiple access devices 204, such as a desktop computer, a laptop computer, a personal digital assistant (PDA), a smart phone, a mobile device, and so forth. The integrated online/offline workspace comprises the user interface 206, which is displayed on the user access device 204, and the server-side architecture 208 which supports the present system in a manner as described later with reference to FIG. 5.

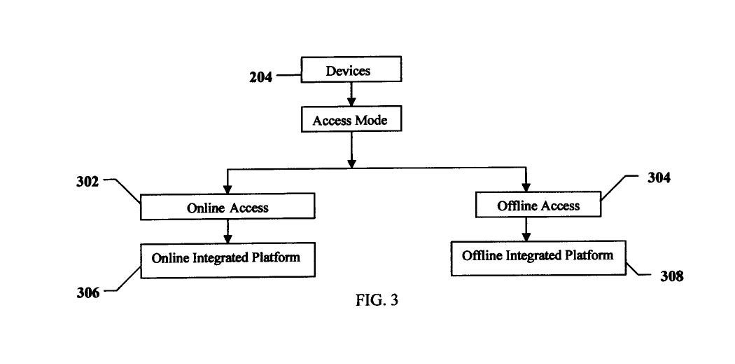

FIG. 3 illustrates a flow diagram showing two major components of the service framework, namely, an online workspace 306 and an offline workspace 308. These two workspaces 306 and 308 are parts of an integrated workspace and are synchronized with each other. As will be appreciated by those skilled in the art, the synchronization may be carried out in real time or at periodic intervals upon establishment of a secured or trusted communication network between the user access device and the backend servers. It should be noted that synchronization ensures that the two workspaces are concurrent with each other such that any addition, removal, or modification of any data item in one of these workspaces is reflected accordingly in the corresponding data item on the other workspace. The online workspace 306 can be accessed in an online access mode 302 as a desktop application, as a web-browser application, or as a toolbar plug-in on a web-browser. The offline platform 308 can be accessed in an offline access mode 304 as a desktop application accessible locally on the user access device 204.

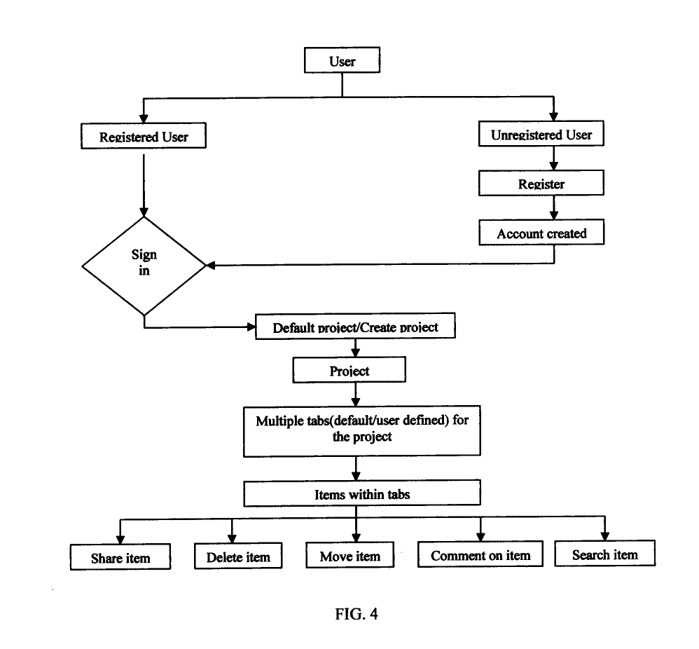

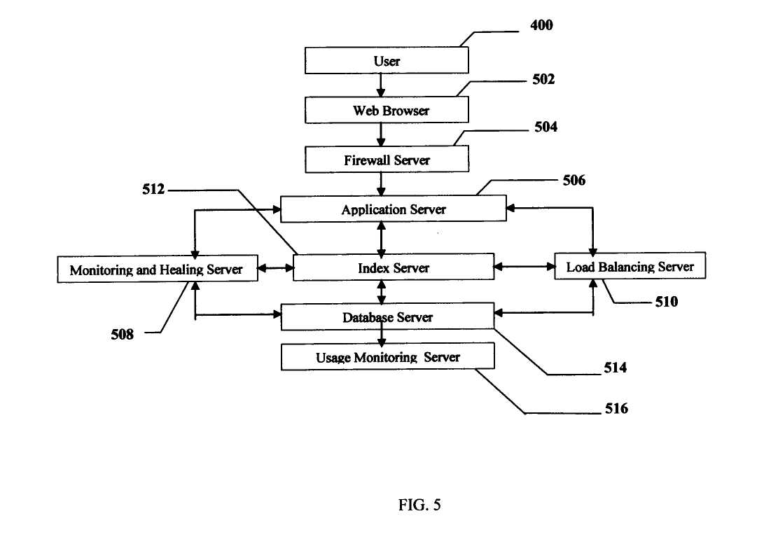

Referring now to FIG. 4, an aspect of a user interface for viewing and managing digital contents is illustrated in accordance with aspects of the present invention. In order to access the online and offline workspaces offered by the present system, a user is required to have an account with the service framework. The user may create the account by getting registered on the service framework 202. For registration, the user may utilize any of his authenticated e-mail addresses. Once the account is created, or if the user is already registered, he can sign-in and get access to the online and offline platforms provided by the service framework. Both the online and offline platforms provide a user-oriented context-based workspace instead of the automatically generated semantics-based context. The user is provided with the ability to define as many contexts as the user needs, such as client, subject, project name, deal, product, goal, and so forth. Each of the contexts is treated as a project in the service framework described herein. If the user does not define any context, a pre-defined default context or project is automatically activated within the workspace. Once a context or a project is selected, for example ‘Client XYZ’, the user can create and save any digital contents as items within multiple sub contexts or tabs. Again, it should be noted that the sub-contexts or tabs are either pre-defined (e.g., saved items, emails, bookmarks, deleted items, and so forth) or user-defined (profile, feedbacks, invoices, and so forth). The digital contents include, but are not limited to, an audio digital data, or a video digital data, or a textual digital data, or an audio/video digital data, or a graphic digital data, a webpage, a link to a webpage, PowerPoint presentation, a Word document, a notepad document, an Excel file, or the like.

Referring now to FIG. 5, the server-side architecture of the service framework 202 is illustrated. In the illustrated embodiment, the user 400 interacts with the service framework 202 through a web-browser 502. For example, the user 400 may send a request or initiate a thread to access various applications residing on an application server 506. The request or the thread passes through a firewall server 504 which checks and certifies the authenticity of the user 400. After checking the authenticity of the user, the firewall server 504 allows the user to access various applications residing on the application server 506. The user can therefore create, manage and share various digital contents through applications residing on the application server 506. All of the digital contents, requests, and/or threads are managed by an index server 512. The index server 512 indexes and stores these digital contents, requests, and/or threads on a database server 514. It is likely that multiple users may access the application server 506, the index server 512, and the database server 514 at about same time and that may slow down the execution of various active requests or threads coming from different users. A load balancing server 510 manages these multiple requests or threads and balances the load of various requests or threads on the application server 506, the index server 512, and the database server 514 by logically distributing the requests or threads among multiple application servers 506, index servers 512 and database servers 514. Additionally, multiple users may create, manage and share requests or threads at about the same time on the application server 506, the index server 512, and the database server 514 and that may result in errors during the process thereby affecting the active requests or threads. A monitoring and healing server 508 may be employed to monitor and repair the above errors. Further, in certain embodiments, the monitoring and healing server 508 may be employed to reconstruct the complete database of indexed and stored digital contents if by any chance the database server 514 crashes resulting in corruption of database. The reconstruction of the database may be carried out by comparing online and offline versions of the digital contents between multiple user access devices and database servers and determining missing digital contents on the database servers based upon comparison. The missing digital contents are then copied from the user access devices, indexed, and stored again on the database servers. Additionally, a usage monitoring server 514 may be communicatively connected with the application server 506, the index server 512, and the database server 514 to monitor account usage and usage pattern of the authorized users. The usage monitoring server 514 dynamically maintains the usage pattern of the applications on the application server 506 and/or digital contents on the database server 514. Such monitoring of usage pattern may be effectively employed to provide better user experience and user interface through customization, better security adherence, and so forth. For example, an analysis of usage pattern of a particular user may be employed to customize the user interface such that the most commonly used applications are visibly available to the user. Similarly, for an enterprise client, an analysis of usage pattern of a user employed with the enterprise may be necessary so as to restrict the download of sensitive and confidential data on the user's personal device.

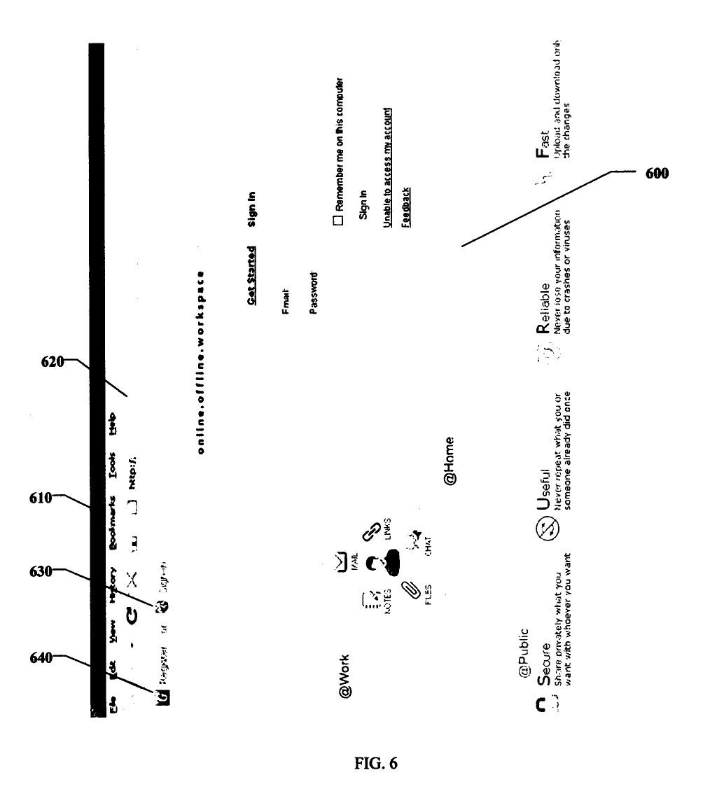

Reference will now be made to FIGS. 6-15, wherein snapshot diagrams of the online integrated platform 306 have been illustrated to explain the features and working of the present system in greater detail. FIG. 6 is a screenshot diagram of home page 600 of the present service framework 202, wherein a registered user can sign-in to access his account and also an unregistered user can create his account. The home page 600 can be opened on a web browser 610 by directly typing the web-page address, specific to the service framework 202, in address bar 620 of the web-browser 610. However, if the service framework 202 has been previously downloaded as a plug-in toolbar on the web-browser 610, the registered user can directly sign into his account through a sign-in-icon 630 while the unregistered user can get started with the registration process by clicking on a register-icon 640. The service framework 202 allows a registered user to add other registered users to his account as friends or colleagues, thereby enabling them to communicate, create, and/or share digital contents among themselves. Additionally, the service framework may assign a pre-defined storage limit or profile space on the server to each of the registered user based on the user's subscription type. For example, a premium user may be assigned a higher profile space than a normal user. Similarly, a user belonging to enterprise client may have higher profile space than an individual user.

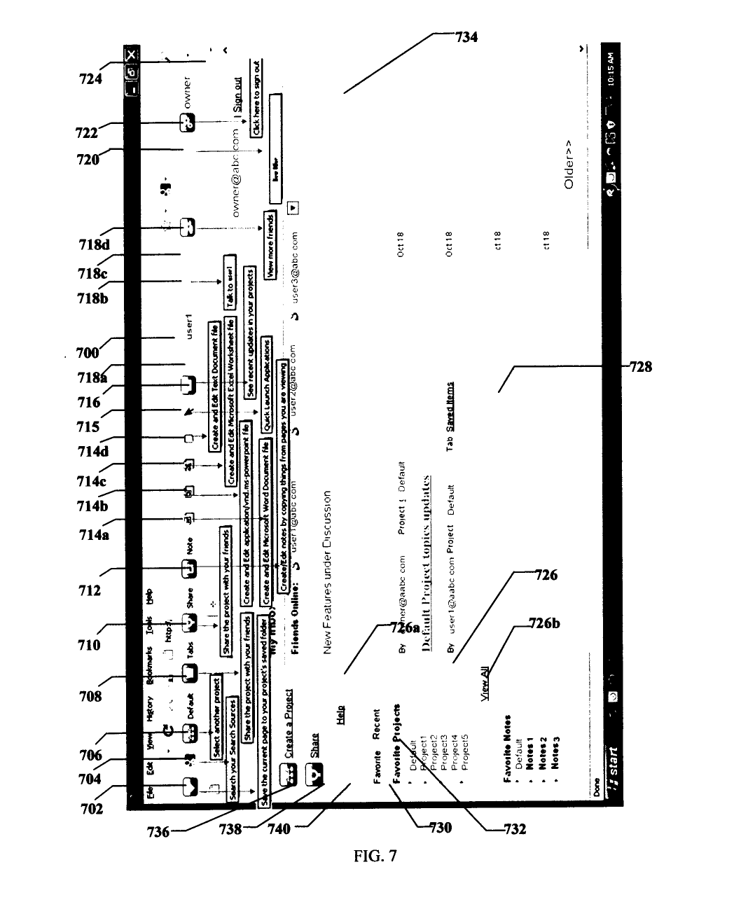

Turning now to FIG. 7, a user interface of the online integrated platform 306 is illustrated. The illustrated user interface is displayed to the user once the user signs into his account. The interface displayed herein and in subsequent screenshot diagrams represent an account of a user who has already worked at least once on this platform and not that of a new user who has for the first time signed into his account. It should be noted that the discussion provided herein is with reference to a used account in order to provide a better understanding of features and functionalities of the present invention. The major components of the interface are: a toolbar as represented by 700, a chat bar 734, a side window as represented by 726, and a main window 728. The toolbar 700 of the present system comes with a scroll button which when clicked flips the current toolbar with a new toolbar that a user may want to use. For example, if a user has multiple toolbars he may not use and hence may not wish to view all the toolbar in his browser at the same time. Mostly, these toolbars are website specific and best used with that particular website. For example, the toolbar from Zyanga® for its popular Farmville application is best for that particular application and is of limited or no use when the user is surfing web for other content or working. In that case, the user do not want that particular toolbar and may be interested only in a generic toolbar that allows him to quick search and so forth such as google toolbar. The user then just have to click and the toolbar flips or rotates over to show google toolbar and hides the Farmville toolbar from the browser and the user. The advantage of having such a tool or application is to have multiple toolbars without cluttering the toolbar space or the browser window.

The toolbar 700 for the present system further comprises a plurality of selectable toolbar icons that offer a wide range of applications to the user. Functions of these toolbar icons are later discussed with reference to corresponding snapshot diagrams. The user interface further includes a side window 726 that further comprises two sub-widows: 726(a) and 726(b). The sub-window 726(a) comprises a plurality of selectable icons that provide the user with quick access to various functionalities or features of the present invention. For example, as illustrated in FIG. 7, the sub-window 726(a) comprises three selectable icons indicated by reference numerals 736, 738, and 740. Indicated by 736 is ‘create a project’ icon for creation of user-defined projects. Upon clicking the icon 736, the user is asked to create a project, for a user-defined context, and to also name the project being created. The user can create any number of projects he desires to create. Further, a user can quick share any of the existing projects with other users via selectable icon 738. Additionally, a help menu describing important features of the service framework 202 is also provided to the user for his quick reference. User can access this help menu by clicking on a selectable icon 740. It should be noted that the user can also use toolbar to achieve above objectives besides using quick selectable icons available in sub-window 726(a). For example, a toolbar icon 720 may be employed to access help menu besides using the selectable icon 740. Further it should be noted that selectable icons of the sub-window 726(a) is highly customizable based on user preferences. The customization may be done manually by the user or may be done automatically based on usage pattern.

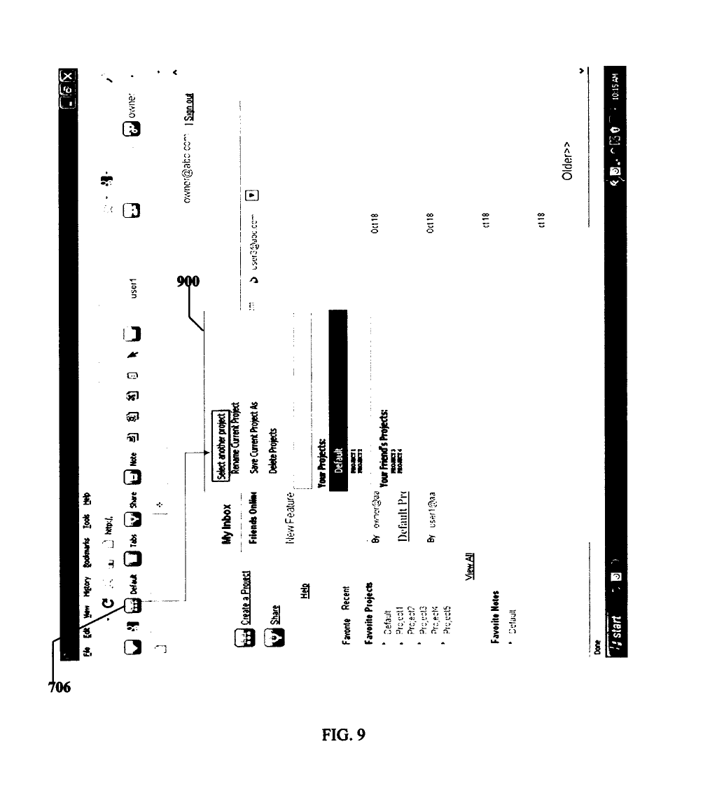

The sub-window 726(b) includes a favorite-tab 730 and a recent-tab 732. Selecting the tab 730 displays within the sub-window 726(b) a list of favorite projects along with a list of favorite notes created using a notebook application accessible through a toolbar icon 712. Similarly, selecting the tab 732 displays within the sub-window 726(b) a list of recent projects and recent notes. In order to switch over from a currently active project to a different project, the user can select the different project either from the list of projects displayed within the sub-window 726(b) or through a toolbar icon 706. Upon selection, the toolbar icon 706 opens a drop-down window as shown by 900 in FIG. 9. This window 900 displays a complete or truncated list of projects created by the user as well as all the projects that his friends have shared with him. The window 900 also provides options to the user for renaming, saving or deleting the currently active project. Additionally, a search box is provided within the window 900 to enable the user to search for a particular project among all the projects accessible to the user. It should be noted that the search box is loaded with auto-fill and auto-look feature to make the search easy and convenient for the user.

As described above, selectable icon 738 allows the user to share any project with any number of desired friends added to his account. Upon clicking the icon 738, the user is asked to name the project that he desires to share and to name the friend(s) with whom he desires to share that project. Besides using the selectable icon 738 for sharing the project, the user can also use a toolbar icon 710 for sharing of projects. In one embodiment, the user may share the currently active project the toolbar icon 710. Upon selection, the toolbar icon 710 opens a drop-down window comprising a first set and a second set of friend(s). The first list displays the names of user's friend(s) with whom the currently active project is already shared, while the second list displays the names of rest of the user's friend(s) whom he can select to share the currently active project. Alternatively, the toolbar icon 710 may be configured to function similar to that of icon 738.

The main window 728 displays a list of all the updates and activities related to the various projects or a currently active project in a chronological order. In certain embodiments, the updates and activities related to all of the user's projects is displayed in a separate window upon selection of a toolbar icon 716. Further, in certain embodiments, the user receives alerts whenever there is any update in any of the projects he shares with one or more friends. These alerts can either be real-time alerts such as pop-up window alerts or be delayed alerts such as those received as e-mail messages. Additionally, a chat bar 734 displays a list of user's friend along with their status indicating whether the friend is in an online or in an offline mode. This application enables the users to communicate in near real time. The chat application is described further in greater detail with reference to FIG. 11.

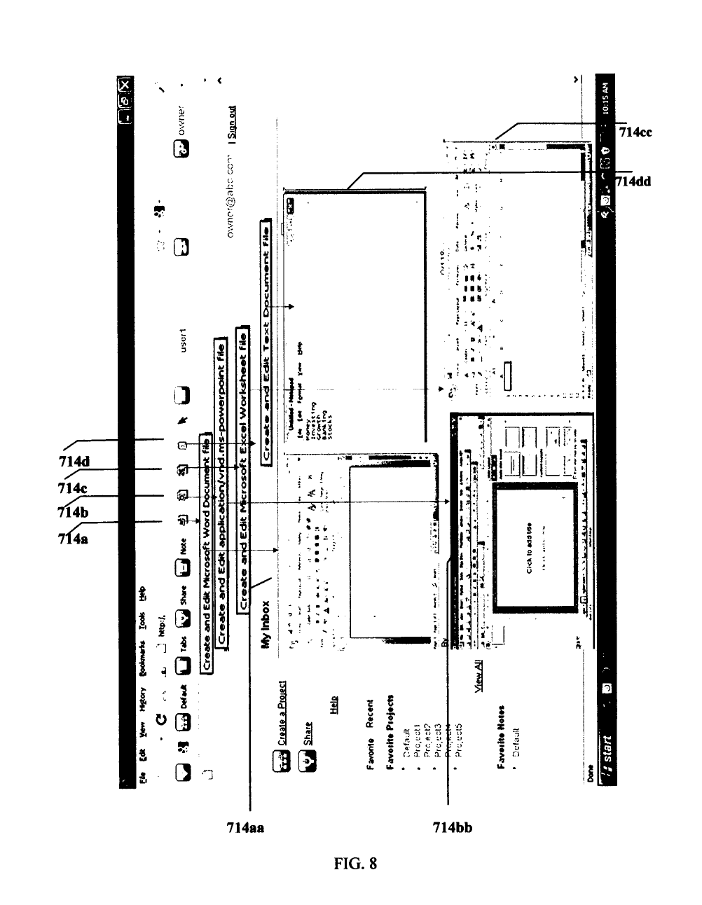

As shown in FIG. 8, the online integrated platform 306 also includes a plurality of data editing applications including, but not limited to, Microsoft Word application, Microsoft PowerPoint application, Microsoft Excel application, Microsoft notepad application represented by toolbar icons 714(a), 714(b), 714(c), and 714(d) respectively. Selection of these toolbar applications opens corresponding windows 714(aa), 714(bb), 714(cc), and 714(dd) respectively. Using these applications, the user can create, open, edit or save such documents as supported by these applications.

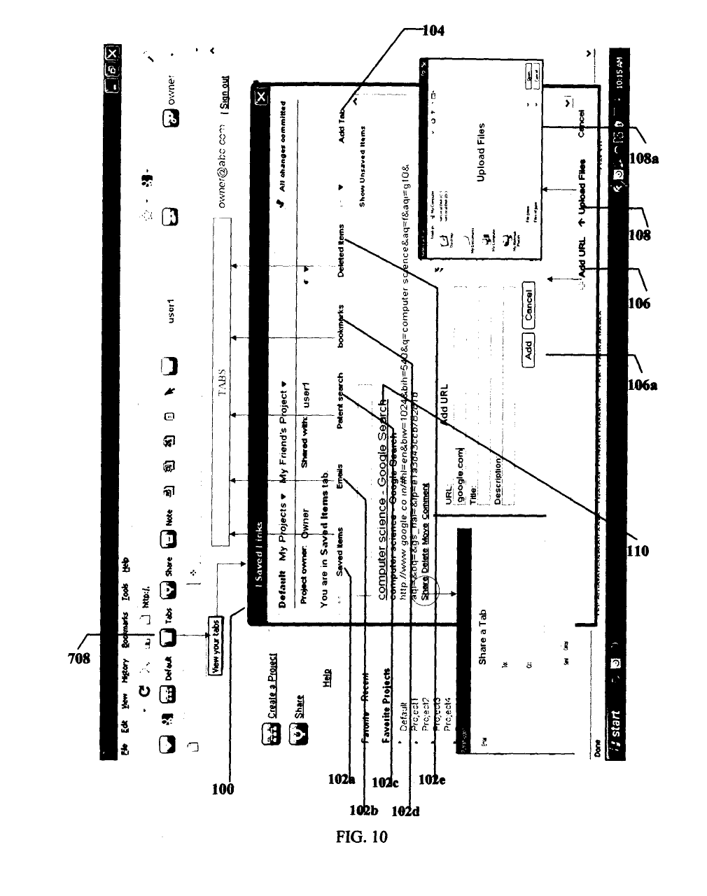

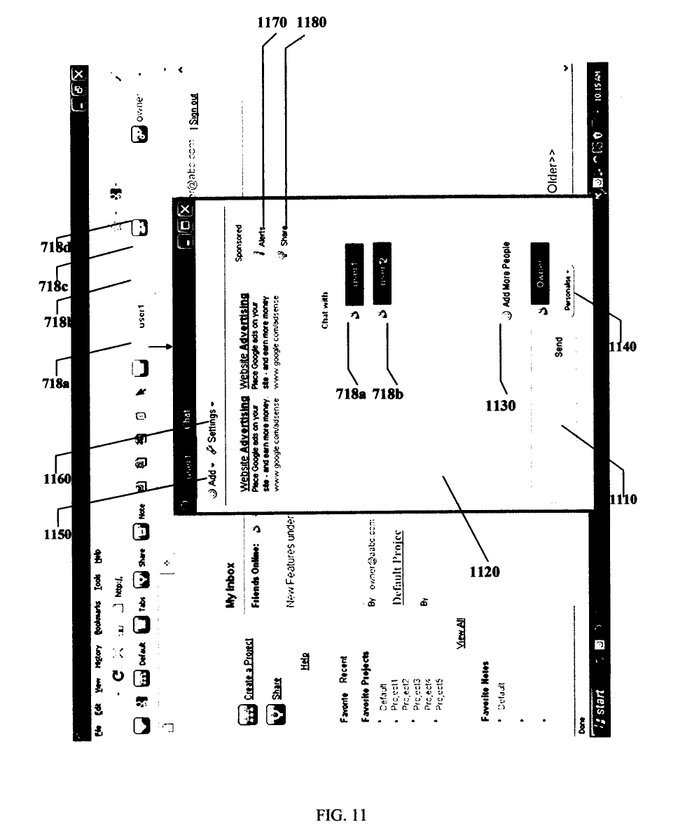

Turning now to FIG. 10, wherein the organization and management of digital data at the project level within a tabs window 100 is shown. Said window can be opened by clicking on a toolbar icon 708. Any digital data related to the project is treated and stored as an item 110 within one or more tabs 102 on the online platform. These tabs can either be default tabs, such as tabs 102(a), 102(b), and 102(e) or be user-defined tabs such as tabs 102(c) and 102(d). The user can add one or more tabs to the tabs window 100 by clicking on the selectable icon 104. These items can be managed in a number of ways such as they can be shared, deleted, moved or commented on by the user or the users with whom the particular project is shared. Another unique feature of the present tabs window 100 is that a URL can directly be added within a desired tab along with a title and description for the URL. This can be done by selecting add-URL-icon 106 which opens a corresponding window 106(a) within which the user can add his desired URL in the space provided. The user can also upload one or more files to the desired tab by selecting upload-files-icon 108 which opens a corresponding window 108(a) from where the user can upload files from the access device 204.

Referring to FIG. 11, the chat application mentioned above is further described in greater detail. The user's friends are displayed as selectable icons on the toolbar 700. For example, in the FIG. 11, selectable icons 718(a), 718(b), and 718(c) represent user's friends. It should be noted that depending on user behavior or preferences, more frequently contacted friends appear as selectable icons. For efficient space utilization on the toolbar, other friends are not shown on the toolbar 700 as selectable icons but displayed on a drop-down window which opens upon selecting toolbar icon 718(d). To initiate a chat with a friend, the user has to click on the friend's name either through the corresponding selectable toolbar icon or through the drop-down window, wherever the friend's name is visible. Suppose the user has selected for friend 718(a), say user1. Upon selecting a user1 for chat, a chat window 1100 is opened. The chat window 1100 comprises a text box 1110 where the user can write his chat message for user1. A conversation window 1120 is also included within the chat window 1100 wherein the ongoing conversation between the user and the user1 is displayed. The user, if so desires, may enter in to a group chat or chat in a collaborative environment with multiple users by selecting one or more desired users through a selectable icon 1130 provided within the chat window 1100. Suppose the user has also selected user2 through icon 1130 or icon 1150, a group chat including the user, user1, and user2 will be initiated. The chat messages from all the three users will be displayed in the same conversation window 1120. As described in certain embodiments, a novel feature of the present framework is single window chat which enables the user to chat individually wih multiple users within the same chat window. For example if the user desires to chat with both user 1 and user2 individually and not in a group chat mode, he can still chat with both of them within the chat window 1100 unlike the other state of the art technologies wherein different chat windows open up for different users. Both the users, user1 and user2, are displayed in the chat window 1100 and the user can switch chatting from user1 to user2 and vice-versa by simply clicking on the desired user's name being displayed. The chat window 1100 also incorporates a share icon 1180 through which the user can share a link with the friends in the chat window.

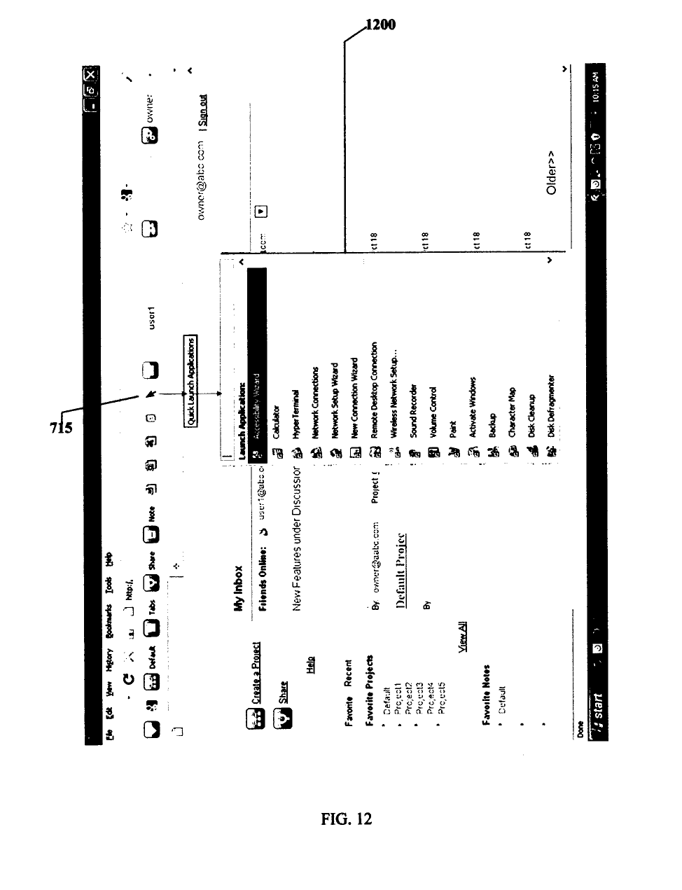

FIG. 12 illustrates a quick launch application featured in the present system wherein a selectable toolbar icon 715 is provided on the toolbar 700. The toolbar icon 715, upon selection by the user, opens a drop-down window 1200. The window 1200 comprises a list of applications available locally on the user access device 204. Thus the desktop applications of the user access device 204 can be directly launched using this application without requiring the user to leave the online integrated platform interface.

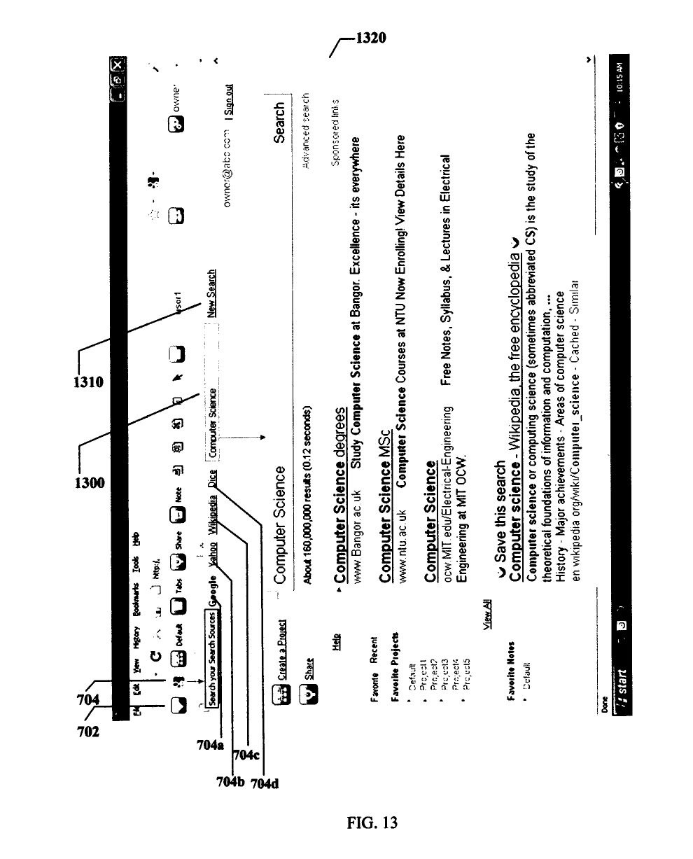

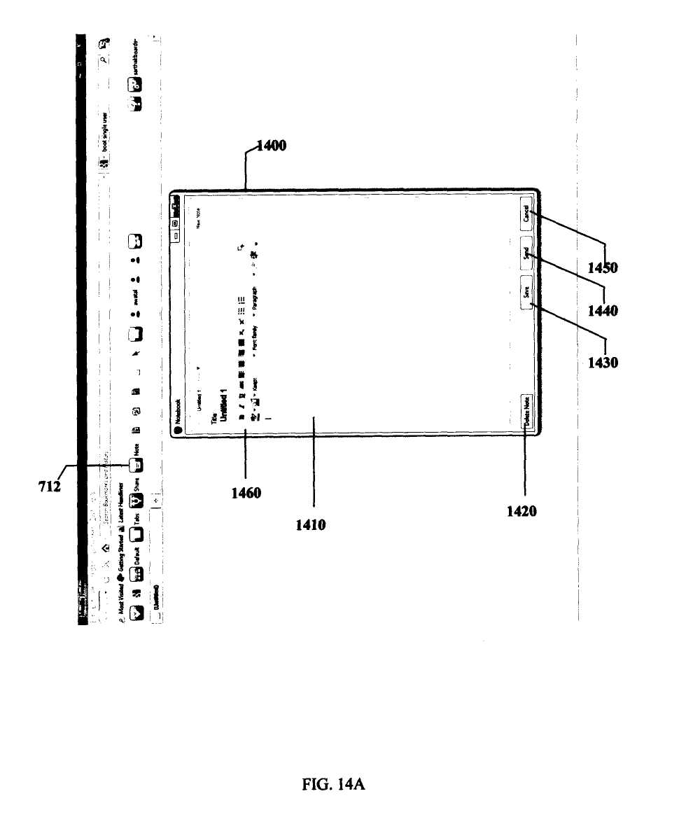

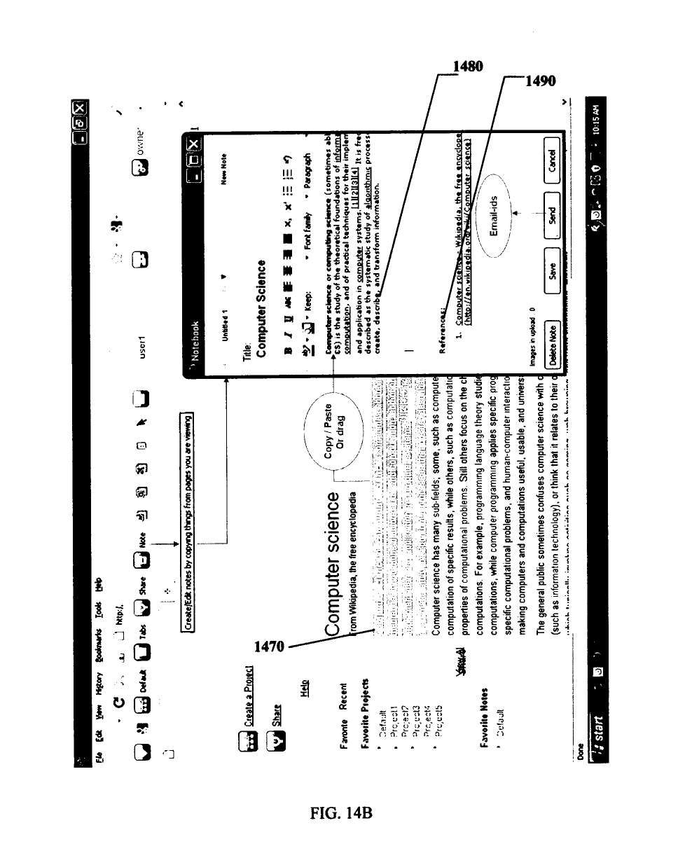

Referring now to FIG. 13, which is a snapshot diagram illustrating a global search application embedded within the online integrated platform 306. The user can select desired search source from a plurality of search sources conjugated with the online integrated platform 306 through a selectable toolbar icon 704. The conjugated search sources in the preferred embodiment are, but not limited to, Google, Yahoo, Wikipedia, and Dice as shown by 704(a), 704(b), 704(c) and 704(e) respectively. A search box 1300 is provided wherein the user can put his query he wants to search and thereby click on the desired search source. Upon hitting the search source, a search result window 1320 is displayed. In order to start afresh with a new search, the user may click a new-search-icon 1310. The online integrated platform 306 also provides a bookmarking application wherein a bookmarking icon 702 on the toolbar 700 can be clicked to bookmark the currently active web-page. It is to be noted that bookmarking a web-page saves it within the currently active project on the online integrated platform 306.

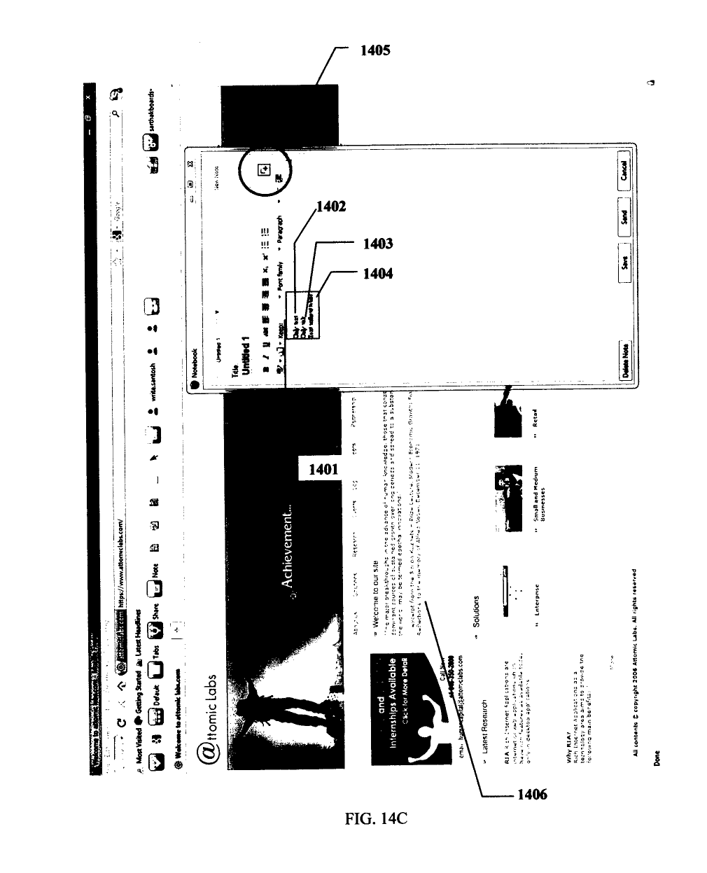

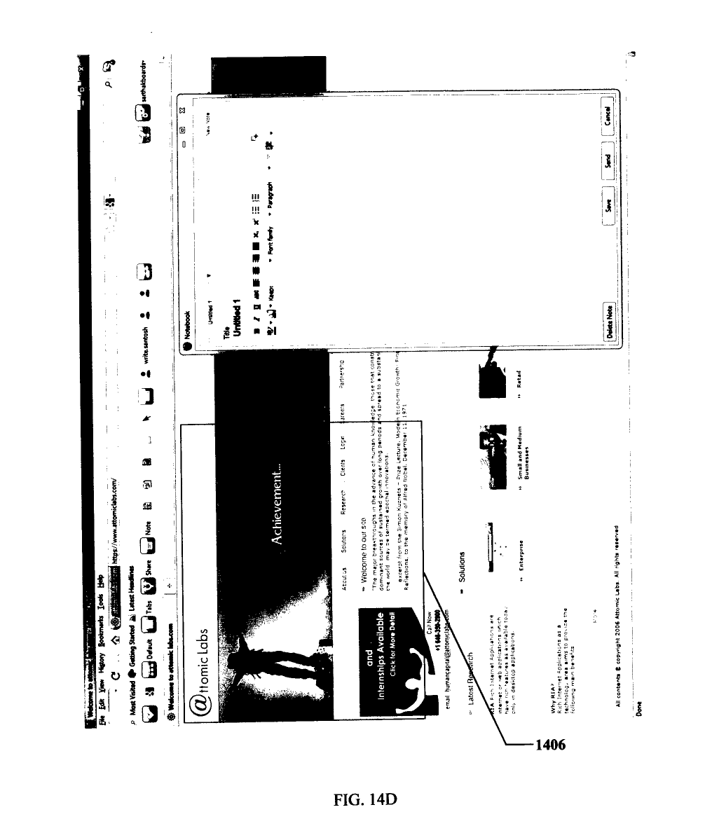

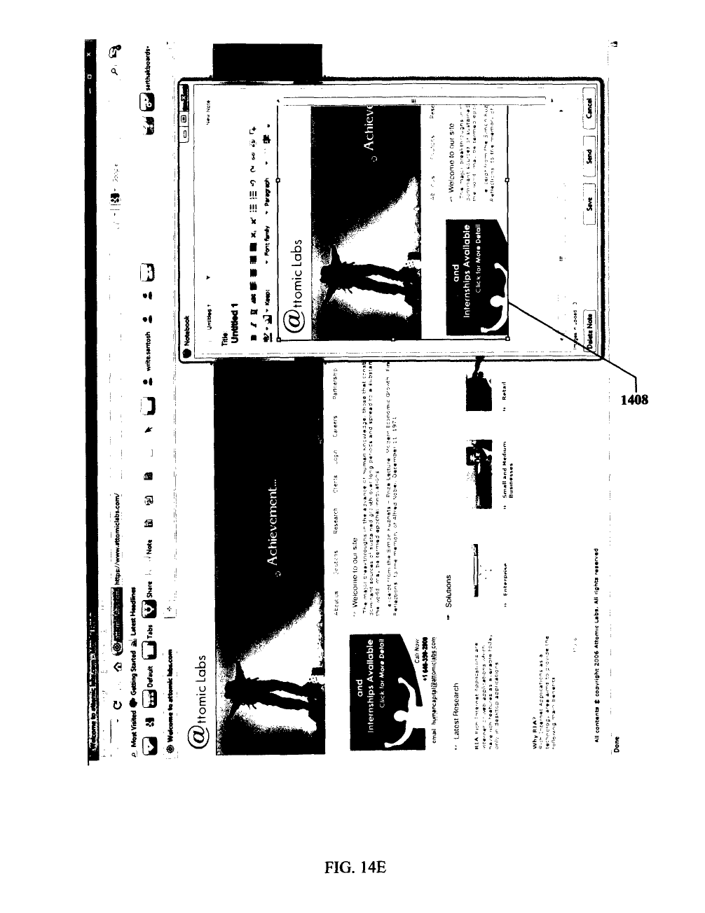

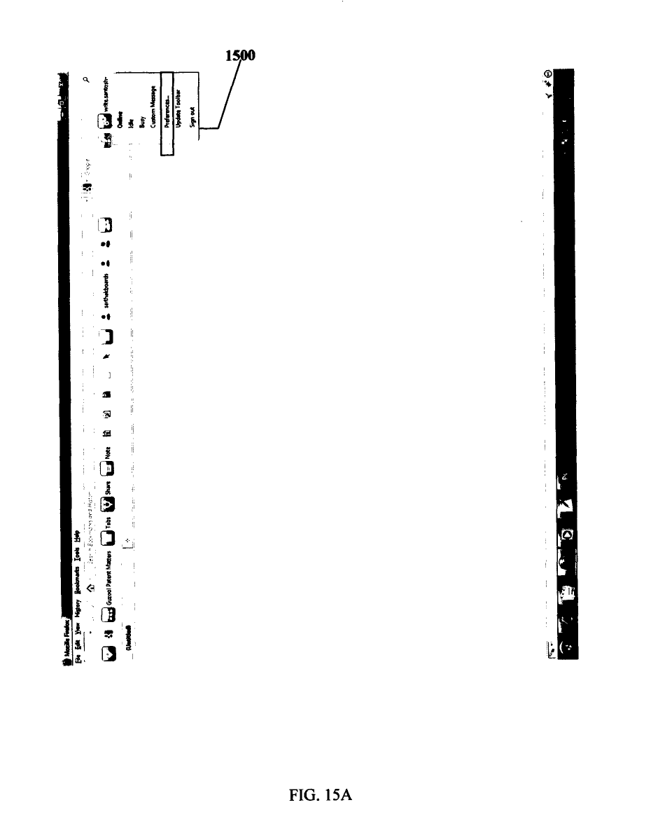

Reference will now be made to FIGS. 14A-14E wherein the figures illustrates a notebook application included in the online integrated platform 306. As shown in FIG. 14A, a notebook application icon 712 can be selected to open a notebook window 1400. The window 1400 comprises a note-box 1410 where the user can create his text note either by directly writing in the note-box 1410 or by pasting desired text from any other location. A text-format bar 1460 is also provided with the note-box to allow the user edit or select a desired format for his textual note. The window 1400 also comprises selectable icons 1420, 1430, 1440 and 1450 for respectively deleting, saving, sending or cancelling the created note. It should be noted that the created note automatically updates itself whenever any changes is made to it and the updates are displayed in the inbox of each of the user that the note is shared with. Additionally, it should be noted that multiple users working on the same note can see all the updates and each other's changes in near real-time. Referring to FIG. 14B, wherein a web-page is open within the main window 728. There can be certain content on the web-page which might interest the user and he would want to save it to his note. In order to accomplish that, the user has to simply select the desired content, as shown by 1470, and thereafter drag and drop it to the note-box. Alternatively, the user can copy and paste the desired contents into the note-box. Shown by 1480 is the desired content from the web-page pasted on the note-box. A reference 1490 to the source web-page of the pasted content is automatically inserted into the note-box along with the pasted content. Alternatively, a desired portion of a web-page can also be pasted in the note-box a web-clip, as shown in FIG. 14C. A web-clip icon 1405 is provided in the notebook window 1400 for the same purpose. The user has to click on the icon 1405 and then select a desired portion 1406 of the currently opened web-page. Upon selection of the desired portion 1406, shown in FIG. 14D it is automatically pasted into the note-box as shown by 1408 in FIG. 14E. Referring back to FIG. 14C, wherein a selectable icon 1401 opens a drop-down window and gives options to the user to selectively keep only text, option 1402, or only URLs, option 1403, or text without tables, option 1404, from the note created.

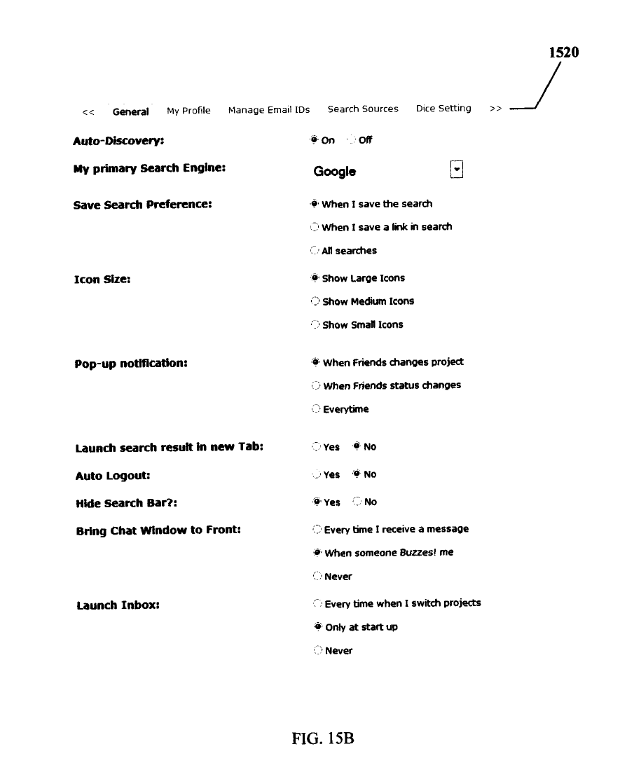

Turning now to FIG. 15A, wherein a selectable toolbar icon 724 is shown. Upon selection, the icon 724 opens a drop-down window 1500. The window 1500 allows the user to set his current status that will be visible to his friends. The status can be online, idle, busy, a custom message, and so forth. The user can also update his toolbar, set preferences for his account, or sign out of his account using the options provided in the window 1500. Shown in FIG. 15B is a preference setting window 1510 wherein the user can set preferences for multiple settings as shown by 1520. The settings can be, for example, general settings, my profile settings, manage e-mail ids settings, search sources settings, and so forth.

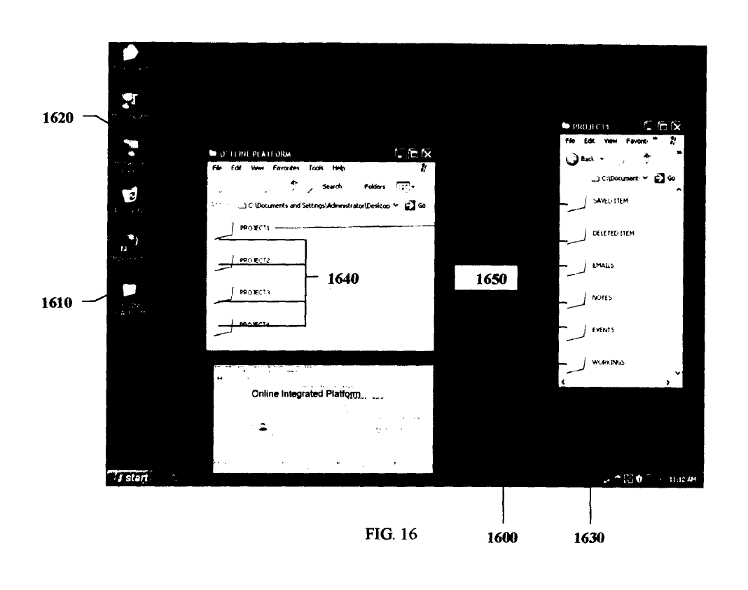

Referring now to FIG. 16, a novel aspect of the present invention is the offline platform 308 that enables the user to work on his digital data stored within the online integrated platform in an offline mode without requiring a secured network connection. The service framework 202 of the present invention automatically creates a folder 1610 on desktop screen 1600 of the user access device 204. It should be noted that the folder 1610 is structured in a context-based manner, similar to context-based structuring of the online integrated platform 306, and offers an offline platform 30. Upon opening the folder 1610, a window 1620 is displayed. The window 1620 contains the full gamut of context or project folders 1640, corresponding to the range of contexts or projects saved by the user within the online integrated platform 306. Upon opening any context or project folder 1640, a window 1630 is displayed. The window 1630 further comprises a plurality of sub-folders 1650, corresponding to the plurality of sub-contexts or tabs within that particular project 1640. Each of the sub-folders comprises the items corresponding to items contained in the tab it represents. This offline folder 1610 gets automatically synchronized with the online integrated platform 306 upon detection of a secured network connection when the user signs into his account on the service framework 202 and accesses the online integrated platform 306. During the synchronization process, any modification of an item 110 accordingly modifies the corresponding item in the tab folder 1650 of the offline platform. Similarly any modification made in an offline mode on an item in the tab folder 1650 accordingly modifies the corresponding item 110 stored on the online integrated platform 306.

While only certain features and embodiments of the invention have been illustrated and described herein, one skilled in the art will recognize that many variations and combinations of these embodiments can be carried out without departing from the scope and spirit of the invention. It is, therefore, to be understood that the appended claims are intended to cover all such variations and combinations as fall within the true spirit of the invention.

1. A computer-implemented system for managing a digital content, the system comprising:
an end-user access device comprising a user interface for enabling an end-user to view and manage a digital content;
an online work platform accessible to the end-user through the user interface, a communication network, and the end-user account on the online work platform, wherein the online work platform comprises a plurality of applications to manage the digital content under one or more tabs within one or more context-based projects;
an application server in communication with the end-user access device to operate the plurality of applications and to receive, process, and respond to one or more end-user actions;
a data server in communication with the application server to index and store the digital content; and
an offline work platform on the end-user access device in communication with the online work platform to enable the end-user to work in an offline mode.

2. The system of claim 1, wherein the end-user access device comprises a desktop computer, a laptop computer, a personal digital assistant, a smart phone, or a mobile phone.

3. The system of claim 1, wherein the end-user can add other end-users of the online work platform in his or her account.

4. The system of claim 1, wherein the context-based project is a default project such that unless manually altered by the end-user, all digital content is saved and managed from this default project.

5. The system of claim 1, wherein the context based project is a user-defined project such that the user can create a number of projects to organize, categorize, catalog and manage digital content.

6. The system of claim 1, wherein the one or more tabs are pre-defined or user-defined.

7. The system of claim 1, wherein the digital content comprises any of or a combination of the following: text; graphics; audio files or audio web-links; video files or video web-links; whole or portions of web-pages; uniform resource locators or web-links; and other similar digital content.

8. The system of claim 1, wherein digital content can be created using applications provided in the platform or can be uploaded into the end-user's account on the platform within a desired tab or can be directly saved from a main search engine query results page or from a web-page.

10. The system of claim 1, wherein management of digital content includes, but is not limited to, capturing, storing, processing, sharing, distributing, retrieving, reusing, deleting, commenting on, giving feedback or instructions on digital content as well as relocating digital content within tabs and/or projects.

11. The system of claim 1, wherein a first user shares a project with a second user added to his or her account and thereby extends the ability to manage digital content contained in that project to the second user.

12. The system of claim 1, wherein three key user alerts can be generated by the online platform whenever there is an update in any project: (1) an alert is generated and displayed on the end-user's account's main page informing the end-user of the project that has been updated, the precise digital content that has been updated in the project, the date and time of the update, details of the user who updated the content, including any comments, feedback, or instructions left by that user; (2) a real-time alert displayed in a pop-up window identifying or describing the update; and, (3) an e-mail alert sent to the end-user's email account associated with the end-user's account on the platform.

13. The system of claim 1, wherein a toolbar is provided on the platform, said toolbar comprising a plurality of selectable toolbar icons that allow access to applications embedded in the platform as well as can directly launch applications installed locally on the user access device.

14. The system of claim 13, wherein one or more toolbar icons opens a drop-down window when selected.

15. The system of claim 1, wherein the end-user can collaborate with other users, added to his account, in real time by using a notebook application which allows the user to create digital content, including clipping and capturing desired parts of a webpage.

16. The system of claim 15, wherein desired parts of a web page can be selected, dragged and dropped on the note created with the notebook application while clipping and capturing desired parts of a webpage.

17. The system of claim 15, wherein a citation of the clipped or captured web page is automatically saved to the note along with the clipping of the desired part.

18. The system of claim 15, wherein the notebook application includes a filter application to filter option which allows the user to keep within the note either the clipped text or captured image, or the captured image or clipped text without tables or only the URL of the captured or clipped web page.

19. The system of claim 15, wherein all users sharing the digital content created in the notebook can work in parallel and simultaneously on the same content such that updates will appear in the chronological order as they were made.

20. The system of claim 1, wherein the end-user can collaborate with other end-users, added to his or her account, in real time using chat application which provides a single chat window with tabs when communicating with multiple users and enables VoIP Calling.

21. The system of claim 1, wherein the end-user can collaborate with other users, added to his account, in real time using an e-mailing application which allows the users to send notes created or edited on the platform to one or more email addresses.

22. The system of claim 1, wherein the online platform includes an intelligent bookmarking application, a global web search application, or a local internal search application.

23. The system of claim 1, wherein the online platform can be accessed through a locally downloaded application, through a web browser, web browser toolbar plug-in of the end-user access device.

24. The system of claim 1, wherein the offline work platform comprises a plurality of folders containing context related items corresponding to the plurality of context related items on the online platform.

25. The system of claim 24, wherein one or more items in the offline work platform can be created, viewed, modified, or deleted in the offline mode.

26. The system of claim 1, wherein the offline work platform is automatically synchronized with the online platform upon establishment of a secured communication network.

27. The system of claim 1, wherein the application server and/or the data server use a load balancing application.

28. A computer-implemented system for digital content management, the system comprising:
an end-user access device for enabling an end-user to view and manage one or more digital contents on an integrated platform accessible to the user through a user interface, the integrated platform configured to store, organize and display one or more digital contents as items within one or more tabs in at least one context-based project;
an application server in communication with the user access device to operate one or more applications and to receive, process, and respond to one or more user actions; and
a data server in communication with the application server to index and store one or more digital contents.

29. The system of claim 28, wherein the user interface comprises a desktop application or a web-browser based application.

30. The system of claim 28, wherein the web browser based application is a web browser toolbar plug-in.

31. The system of claim 28, wherein the integrated platform is online platform and wherein the user accesses the online integrated platform through the user interface by providing user's account authentication information.

32. The system of claim 28, wherein the integrated platform is an offline platform on the user access device to enable the user work in an offline mode and wherein the offline platform is in communication with the online platform upon detection of a secured communication network.

33. The system of claim 28, wherein the integrated platform further comprises a plurality of applications for digital content management.

34. A method for managing a digital content, the method comprising:
providing an integrated platform to an end-user, wherein the end-user interacts with the integrated platform via a user interface on the end-user access device;
providing within the integrated platform a plurality of applications to manage the digital content in a context-based manner within one or more tabs;
indexing and storing the digital content; and
displaying the digital content to the user on user interface.

35. The method of claim 34, wherein the plurality of applications comprises an online communication application, or a document editing application, or a document sharing application, or a document storage application, or a bookmarking application, a web search application.
